(19) United States
(12) Patent Application Publication
(10) Pub. No.: US 2017/0132311 A1
(43) Pub. Date: May 11, 2017

(54) KEYWORDS TO GENERATE POLICY CONDITIONS

(71) Applicant: Hewlett-Packard Development Company, L.P., Houston, TX (US)

(72) Inventors: Helen Balinsky, Cardiff (GB); Alexander Balinsky, Cardiff (GB); Boris Dadachev, Bristol (GB); Shivaun Albright, Rocklin, CA (US)

(21) Appl. No.: 15/320,223

(22) PCT Filed: Jun. 27, 2014
(86) PCT No.: PCT/US2014/044596

§ 371 Date: Dec. 19, 2016

(51) Int. Cl. G06F 17/30

(52) U.S. Cl. CPC G06F 17/30616; G06F 17/30707

(57) ABSTRACT

Examples relate to providing keywords to generate policy conditions. Examples include a computing device to remove, from a corpus of documents, words that are common among classes in the corpus to create a reduced corpus. In some examples, the computing device is to identify a set of keywords for a particular one of the classes in the reduced corpus by identifying keywords that are common among documents in the particular class, and provide the set of keywords to generate a policy condition.

### BACKGROUND

With the number of electronically-accessible documents now greater than ever before in business, academic, and other settings, techniques for effectively managing access to certain documents or groups of documents by particular users or groups of users are of increasing importance. For example, in some applications, a business, academic organization, or other entity may desire to automatically or manually classify documents in a corpus of documents into categories, access to which may be controlled by a number of policy conditions.

### BRIEF DESCRIPTION OF THE DRAWINGS

The following detailed description references the drawings, wherein:

FIG. 1 is a block diagram of an example computing device for providing keywords to generate policy conditions;

FIG. 2 is a block diagram of an example computing device for providing keywords to generate policy conditions by assigning meaningfulness scores to words in a corpus of documents;

FIG. 3 is a flowchart of an example method for providing keywords to generate policy conditions;

FIG. 4 is a flowchart of an example method for providing keywords to generate policy conditions by removing, from a corpus of documents, words that are common in the corpus and adding, to a particular set of keywords, words that are common in a particular class of documents;

FIG. 5 is a flowchart depicting the effects, on a corpus of documents, of the example method depicted in FIG. 4.

### DETAILED DESCRIPTION

As noted above, in some applications, a business, academic organization, or other entity may desire to automatically or manually classify documents in a corpus of documents into categories, access to which may be controlled by a number of policy conditions. Such policy conditions may be based on sets of keywords associated with each category of documents. In each of these scenarios and in numerous other applications, the effectiveness of the system is highly dependent on the quality of the keywords identified for each class. A set of keywords for a particular class should be common for the class but should distinguish the class from the rest of the corpus. Thus, the accuracy of a keyword identification process for providing sets of keywords for classes in a corpus is of importance.

In applications such as in business, academia, or other fields, administrators may be challenged to set proper policy conditions regarding access to documents or files within large databases. In order to customize a particular user or user type's access to categories of documents, policies may be generated based on keywords that distinguish different categories of documents. However, with the rapid increase in data in recent years, properly categorizing and identifying documents in a corpus has become more and more challenging.

Example embodiments described herein provide sets of keywords to generate policy conditions based on the Helmholtz principle, which stands for the general proposition that an observed event is perceptually meaningful if it has a very low probability of appearing in noise. In other words, events that are unlikely to happen by chance are generally perceived. Thus, as adapted to the providing of keywords, example embodiments disclosed herein are based on the idea that keywords for a given class of document are defined based not only on the documents in the class themselves, but also by the context of other documents in other classes in a corpus of documents. Example embodiments are further based on the idea that topics or keywords are signaled by unusual activity, whereby a keyword for a class of documents corresponds to a set of features of that class that rise sharply in activity as compared to an expected activity.

In accordance with these principles, examples disclosed herein relate to a keyword providing process based on a meaningfulness score determined for each word with respect to each class within the corpus and with respect to each document within each particular class. Thus, as an example, a computing device may remove, from a corpus of documents which contains documents of different classes, words that are common among classes in the corpus to create reduced corpus. The computing device may then identify a set of keywords for a particular one of the classes in the reduced corpus by identifying keywords that are common among documents in the particular class. Finally, the computing device may provide the set of keywords to generate a policy condition. Policy conditions may be generated for the particular class according to the set of keywords provided by this process. This process may be repeated to generate policy conditions for each class of documents within the corpus. In this manner, example keyword providing procedures disclosed herein allow for accurate and efficient identification of keywords that are not only common in the class for which they are identified but are also discriminative from other classes.

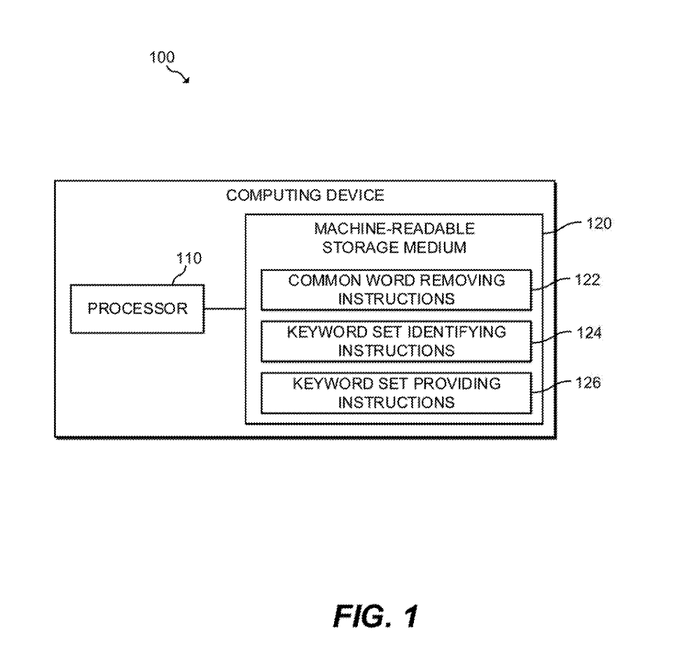

Referring now to the drawings, FIG. 1 depicts an example computing device 100 for providing keywords to generate policy conditions. Computing device 100 may be, for example, a workstation, a server, a notebook computer, a desktop computer, an all-in-one system, a slate computing device, or any other computing device suitable for execution of the functionality described below. Furthermore, in some examples, the functionality of computing device 100 may be distributed over multiple devices as part of a cloud network, distributed computing system, and/or server architecture. In the example of FIG. 1, computing device 100 may include a processor 110 and a non-transitory machine-readable storage medium 120 encoded with instructions executable by processor 110.

Processor 110 may be one or more central processing units (CPUs), semiconductor-based microprocessors, and/or other hardware devices suitable for retrieval and execution of instructions stored in machine-readable storage medium 120. Processor 110 may fetch, decode, and execute instructions 122, 124, 126 to implement the keyword providing procedure described in detail below. As an alternative or in addition to retrieving and executing instructions, processor 110 may include one or more electronic circuits that include electronic components for performing the functionality of one or more of instructions 122, 124, 126.

Machine-readable storage medium 120 may be any electronic, magnetic, optical, or other physical storage device that contains or stores executable instructions. Thus, machine-readable storage medium 120 may be, for example, Random Access Memory (RAM), an Electrically Erasable Programmable Read-Only Memory (EEPROM), a storage device, an optical disc, and the like. Storage medium 120 may be a non-transitory storage medium, where the term “non-transitory” does not encompass transitory propagating signals. As described in detail below, machine-readable storage medium 120 may be encoded with a series of executable instructions 122, 124, 126 for removing common words, identifying a set of keywords, and providing the set of keywords

Machine-readable storage medium 120 may include common word removing instructions 122, which may remove, from a corpus of documents, words that are common among classes in the corpus to create a reduced corpus, where the corpus includes documents of different classes. As used herein, a corpus of documents may also be a separate compilation of all documents within the corpus that may be examined with the process described herein. For example, all words in the corpus may be stored in a temporary list while common words are removed from the temporary list by common word removing instructions 122 and so forth. In some other examples, the corpus may simply be the actual collection of the documents. Generally, a corpus may be a large and structured set of files, which are generally electronically stored and processed. The corpus may contain various documents and texts. The documents may be in a single language or multiple languages. The corpus may contain documents that are in different classes. A class may be a category with which documents may be associated. Tagging a document into a class may aid in organizing a large corpus of documents.

As defined herein, common words may be words that appear persistently or frequently within a given source and should not be interpreted to mean the standard definition of the most frequently used words in a language. As used herein, common words are those words that are shared within a given source. For example, a common word may be common among multiple classes of a corpus and non-discriminatory for any particular class within the corpus. Word removing instructions 122 may remove words that are common among classes in the corpus by first identifying words that appear recurrently throughout the corpus. In some examples, common word removing instructions 122 may remove common words from the corpus by first assigning at least one meaningfulness score to each word in the corpus, where each score is associated with a given class in the corpus, and then removing words from the corpus based on their respective meaningfulness scores. For example, a word may be considered common if its score is less than or equal to a threshold score. In some examples, common words may include words, phrases, combinations of words, or combinations of phrases.

A meaningfulness score may be a representation of the regularity of a word's appearance within a body of text under consideration. For example, as used by word removing instructions 122, a meaningfulness score may represent a word's regularity among all documents within a class. In some examples, the meaningfulness score is assigned to each particular word in the corpus based on the length in words of the corpus, the length in words of the given class for which the score is being assigned, the frequency of the particular word in the corpus, and the frequency of the particular word in the given class for which the score is being assigned. Word removing instructions 122 may include instructions to determine these factors and calculate a score based on these factors.

In operation, word removing instructions 122 may assign multiple meaningfulness scores to each word, where each score represents the word's appearance in the class for which the score was calculated, and then remove words from the corpus based on their respective meaningfulness scores for each class. For example, if the meaningfulness scores assigned to a particular word meet certain criteria—for instance, all scores are zero or less—then the particular word may be removed from the corpus. This may mean that the particular word is common among all or most classes in the corpus. Running this process for all words in the corpus may remove all words that are common in the corpus and leave behind words that are unusual for one or more class to create the reduced corpus.

In some other implementations, word removing instructions 122 may follow a different sequence of steps in removing the common words. For example, word removing instructions 122 may process a class at a time, rather than a word at a time. In such examples, word removing instructions 122 may process a first class by assigning a score to each word in the first class. The words and their respective scores may be stored in a temporary file as word removing instructions 122 proceeds through the other classes of the corpus and assigning scores for each class to each word. When word removing instructions 122 has proceeded through all classes in the corpus, word removing instructions 122 may remove words from the corpus based on each word's scores for all classes. For example, if all meaningfulness scores assigned to a particular word meet certain criteria—for instance, all scores are zero or below—then the particular word may be removed from the corpus.

As a specific example of a meaningfulness score calculation, word removing instructions 122 may calculate the meaningfulness score in accordance with the following equation:

$$meaningfulness score = - \frac{1}{m} log [ ( \begin{matrix}K \\ m\end{matrix} ) \frac{1}{{N}^{m - 1}} ] , \qquad [ Equation 1 ]$$

where:

$$N = \frac{d}{w} ,$$

wherein d is the length in words of the corpus and w is the length in words of a specific class,

K is the frequency of the particular word in the corpus, and

m is the frequency of the particular word in the specific class.

In one example, words with a meaningfulness score of less than or equal to zero assigned for each class are removed from the corpus by word removing instructions 122.

Once common words are removed, some classes in the reduced corpus may be empty. For example, a class may have all words removed by word removing instructions 122. Specifically, the class may not contain any words with a meaningfulness score that meet a threshold score, such as greater than zero in the specific example above. In some such examples, the empty classes may be removed from the reduced corpus because no keywords may be identified for the empty class by the operation of the example processes described herein. As such, word removing instructions 122 may additionally include instructions to remove any empty classes from the reduced corpus.

After removal of common words in the corpus, keyword set identifying instructions 124 may identify a set of keywords for a particular one of the classes of the reduced corpus by identifying words that are common among documents in the particular class. A set of keywords may include at least one word that distinguish the particular class. For example, a keyword may be a word that appears frequently in the particular class, but not common among the whole corpus as to be removed earlier by word removing instructions 122. In some examples, a keyword may mean a word, phrase, combination of words, or combination of phrases.

In order to identify a set of keywords for a particular class, keyword set identifying instructions 124 may first assign at least one meaningfulness score to each word in the particular class, where each score is associated with a given document in the particular class, and then add words to the set of keywords based on their respective meaningfulness scores for a sufficient number of documents. For example, if the meaningfulness scores assigned to a particular word meet certain criteria—for instance, a sufficient number of scores are zero or less—then the particular word may be added to the set of keywords. This may mean that the particular word is common among a sufficient number of documents in the particular class, and adding it to the set of keywords names the particular word as a keyword that may distinguish the particular class. Running this process for all words in the particular class may add, to the set of keywords, all words that frequently appear in the class.

The meaningfulness score of a particular word for a given document may be a representation of the regularity of the word's presence within the given document. In some examples, the meaningfulness score is assigned to each particular word in the class based on the length in words of the particular class, the length in words of the given document for which the score is being assigned, the frequency of the particular word in the particular class, and the frequency of the particular word in the given document for which the score is being assigned. Keyword set identifying instructions 124 may include instructions to determine these factors and calculate a score based on these factors.

In some other implementations, keyword set identifying instructions 124 may follow a different sequence of steps in identifying the keywords. For example, keyword set identifying instructions 124 may process a document at a time, rather than a word at a time. In such examples, keyword set identifying instructions 124 may process a first document by assigning a score to each word in the first document. The words and their respective scores may be stored in a temporary file as keyword set identifying instructions 124 proceeds through the other documents of the class and assigning scores for each document to each word. When keyword set identifying instructions 124 has proceeded through all documents in the class, keyword set identifying instructions 124 may add words to the set of keywords based on each word's scores for all documents.

As a specific example of a meaningfulness score calculation, keyword set identifying instructions 124 may calculate the meaningfulness score with a variation of Equation 1. As used by keyword set identifying instructions 124, N equals d/w, where d is the length in words of the particular class and w is the length in words of the given document, K is the frequency of the particular word in the particular class, and m is the frequency of the particular word in the given document. In one example, words with a meaningfulness score of less than or equal to zero assigned for a sufficient number of documents are added to the set of keywords by keyword set identifying instructions 124.

After identification of a set of keywords, keyword set providing instructions 126 may provide the set of keywords to generate a policy condition. A policy condition may be rules, procedures, programs, or a combination of policies that control a corpus of documents and its contents. Furthermore, a policy condition may be based on keywords that distinguish types of documents and classes within the corpus. For example, a policy condition may control content-based access and handling of documents in particular classes. As a specific example, a class of documents within a corpus may be labeled with the keyword “classified.” A policy condition for this particular class may monitor authorized user access to the particular class based on the keyword. In addition, this policy condition may prevent data leaks and other unwanted activities regarding, for example, highly sensitive materials.

Furthermore, a policy condition may be useful for cost optimization of document storage and access. For example, organizations may maintain very large databases, the contents of which may be stored in multiple storage locations. It may be desirable to store certain files locally for easier access, while some files may only be maintained for recordkeeping and may be archived in more cost-efficient locations. Policy conditions may be generated to determine the storage destination of documents according to their classes, which may be labeled by a keyword or set of keywords.

In an example implementation, keyword set providing instructions 126 may provide the set of keywords to generate a policy condition by causing a graphic user interface to display the set of keywords to a user, interacting with a user to receive a set of policy keywords from the user, and generating the policy condition according to the set of policy keywords. The graphic user interface may be displayed directly by computing device 100, or keyword set providing instructions 126 may alternatively cause another device to display the keyword sets, such as via a local or cloud network. Displaying the set of keywords may allow a user to view the keywords for the class and make determinations regarding which words to use as policy keywords for setting policy conditions for the class.

After displaying the set of keywords, keyword set providing instructions 126 may then interact with a user to receive a set of policy keywords from the user. The set of policy keywords may be selected by the user to guide the policy condition. After receiving the set of policy keywords, keyword set providing instructions 126 may generate the policy condition according to the set of policy keywords. In some examples, the set of policy keywords as provided by the user may contain none, some, or all of the keywords in the set of keywords identified by keyword set identifying instructions 124. For example, a user may want to generate policy conditions based on alternative policy keywords selected based on external knowledge. Alternatively in some implementations, machine-readable storage medium 120 may further include instructions to automatically generate a policy condition based on the set of keywords identified by keyword set identifying instructions 124. In such examples, a user may not need to select a set of policy keywords.

In addition to the details above, machine-readable storage medium 120 may further include instructions to pre-process the corpus prior to the execution of instructions 122, 124, and 126. Pre-processing the corpus may edit the documents within the corpus to be better suited for the execution of instructions 122, 124, and 126. Example methods for pre-processing the corpus include removing a predefined set of characters, removing words shorter than a predefined number of characters, and applying a stemming algorithm.

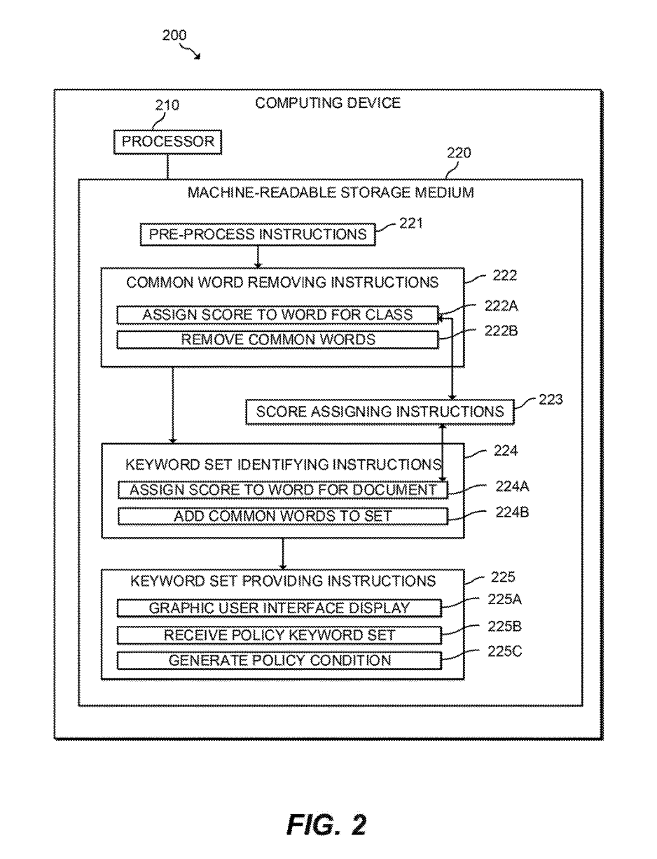

FIG. 2 is a block diagram of an example computing device 200 for providing keywords to generate policy conditions by assigning a meaningfulness score to each word in a corpus of documents. As with computing device 100 of FIG. 1, computing device 200 may be, for example, a workstation, a server, a notebook computer, a desktop computer, an all-in-one system, a slate computing device, or any other computing device suitable for execution of the functionality described below. Furthermore, in some embodiments, the functionality of computing device 200 may be distributed over multiple devices as part of a cloud network, distributed computing system, and/or server architecture. In the example of FIG. 2, computing device 200 may include a processor 210 and a non-transitory machine-readable storage medium 220 encoded with instructions executable by processor 210.

As with processor 110, processor 210 may be a CPU or microprocessor suitable for retrieval and execution of instructions and/or one or more electronic circuits configured to perform the functionality of one or more of instructions 221, 222, 223, 224, 225 described below. Machine-readable storage medium 220 may be any electronic, magnetic, optical, or other physical storage device that contains or stores executable instructions. As described in detail below, machine-readable storage medium 220 may be encoded with executable instructions for providing keywords to generate policy conditions.

Thus, machine-readable storage medium 220 may include pre-process instructions 221, which may pre-process a corpus of documents for which computing device 200 is providing keywords to generate policy conditions. Pre-processing the corpus may edit the documents within the corpus to be better suited for the execution of instructions 222, 223, 224, and 225. Example methods for pre-processing the corpus include removing a predefined set of character, removing words shorter than a predefined number of characters, and applying a stemming algorithm.

After pre-processing the corpus, common word removing instructions 222 may be executed to remove, from the corpus, words that are common among classes in the corpus to create a reduced corpus. Common words may be words that appear persistently or frequently within a given source. Word removing instructions 222 may remove words that are common among classes in the corpus by first identifying words that appear recurrently through the corpus. In some examples, common word removing instructions 222 may execute instructions 222 A to assign at least one meaningfulness score to each word in the corpus by executing score assigning instructions 223, where each score is associated with a given class in the corpus, and execute instructions 222 B to remove words from the corpus based on their respective meaningfulness scores. In some examples, word may mean words, phrases, combinations of words, or combinations of phrases.

In operation, instructions 222A may call on word assigning instructions 223 to assign multiple meaningfulness scores to each word, where each score represents the word's presence in the class for which the score was calculated, and then instructions 222B may remove words from the corpus based on their respective meaningfulness scores for each class. For example, if the meaningfulness scores assigned to a particular word meet certain criteria—for instance, all scores are zero or less—then the particular word may be removed from the corpus. This may mean that the particular word is common among all classes in the corpus, and removing it from the corpus prevent the particular word from being considered as a keyword to distinguish a particular class. Running this process for all words in the corpus may remove all words that are common in the corpus and leaving behind, in the reduced corpus, words that are unusual for one or more class. One specific example for assigning meaningfulness scores to words may be the use of Equation 1 as described in relation to common word removing instructions 122 of FIG. 1.

Following the execution of common word removing instructions 222, keyword set identifying instructions 224 may be executed to identify a set of keywords for a particular one of the classes in the reduced corpus by identifying keywords that are common among documents in the particular class. A set of keywords may include a number of words that distinguish the particular class. For example, a keyword may be a word that appears frequently in the particular class, but not common among the whole corpus as to be removed earlier by word removing instructions 222. In some examples, a keyword may mean a word, phrase, combination of words, or combination of phrases.

In order to identify a set of keywords for a particular class, keyword set identifying instructions 224 may first execute instructions 224A to assign at least one meaningfulness score to each word in the particular class by executing score assigning instructions 223, where each score is associated with a given document in the particular class, and then execute instructions 224B to add words to the set of keywords based on their respective meaningfulness scores for a sufficient number of documents. For example, if the meaningfulness scores assigned to a particular word meet certain criteria—for instance, a sufficient number of scores are zero or less—then the particular word may be added to the set of keywords. The meaningfulness score of a particular word for a given document may be a representation of the regularity of the word's presence within the given document. This may mean that the particular word is common among a sufficient number of documents in the particular class, and adding it to the set of keywords names the particular word as a keyword that may distinguish the particular class. As a specific example of a meaningfulness score calculation, keyword set identifying instructions 224 may calculate the meaningfulness score by the use of a modified version of Equation 1 as described above. Running this process for all words in the particular class may add, to the set of keywords, all words that frequently appear in the class.

Following the execution of keyword set identifying instructions 224, keyword set providing instructions 225 may be executed to provide the set of keywords to generate a policy condition. As described above, a policy condition may be rules, procedures, or programs that control a corpus of documents and its contents. Furthermore, a policy condition may be based on keywords that distinguish types of documents and classes within the corpus. For example, a policy condition may control content-based access to documents in particular classes.

In an example implementation, keyword set providing instructions 225 may execute instructions 225A to cause a graphic user interface to display the set of keywords to a user, instructions 225B to interact with a user to receive a set of policy keywords from the user, and 225C to generate the policy condition according to the set of policy keywords. The graphic user interface may be displayed directly by computing device 200, or keyword set providing instructions 225 may alternatively cause another device to display the keyword sets, such as via a local or cloud network. Displaying the set of keywords may allow a user to view the keywords for the class and make determinations regarding which keywords to use as policy keywords for setting policy conditions for the class.

After instructions 225A has displayed the set of keywords, instructions 225B may then interact with a user to receive a set of policy keywords from the user. The set of policy keywords may be selected by the user to guide the policy condition. Instructions 225C may then generate the policy condition according to the set of policy keywords. Alternatively in some implementations, machine-readable storage medium 220 may further include instructions to automatically generate a policy condition based on the set of keywords identified by keyword set identifying instructions 224. In such examples, a user may not need to select a set of policy keywords.

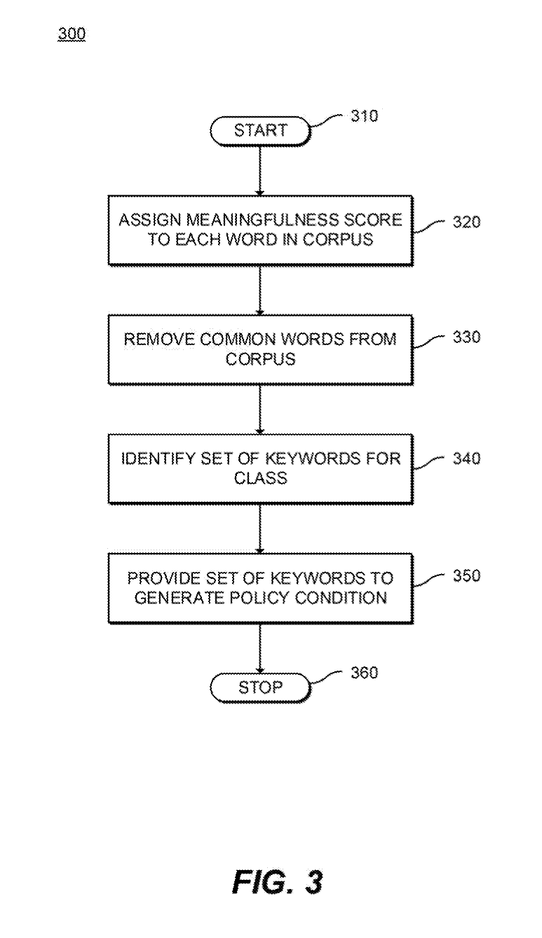

FIG. 3 depicts a flowchart of an example method 300 for providing keywords to generate policy conditions. Although execution of method 300 is described below with reference to computing device 100 of FIG. 1, other suitable components for execution of method 300 should be apparent, including computing device 200 of FIG. 2. Method 300 may be implemented in the form of executable instructions stored on a machine-readable storage medium, such as storage medium 120, and/or in the form of electronic circuitry.

Method 300 may start in block 310 and proceed to block 320, where computing device 100 may assign at least one meaningfulness score to each word in a corpus of documents having documents of different classes. A meaningfulness score may be a representation of the regularity of a word's presence within a body of text under consideration. A meaningfulness score may be assigned to a word for a class or for a document. For example, as used by block 330 for removing common words from the corpus, a meaningfulness score may represent a word's regularity among all documents within a class. Alternatively, as used by block 340 for identifying a set of keywords for a particular class, the meaningfulness score of a particular word for a given document may be a representation of the regularity of the word's presence within the given document.

After assigning a meaningfulness score to a word for all classes in the corpus, method 300 may proceed to block 330, where computing device 100 may remove, from the corpus, words that are common among classes in the corpus to create a reduced corpus. Common words may be words that appear persistently or frequently in the corpus. In some examples, computing device 100 may remove words from the corpus based on their respective meaningfulness scores for all classes. For example, if all meaningfulness scores assigned to a particular word meet certain criteria—for instance, all scores are zero or below—then the particular word may be removed from the corpus. In some examples, common words may include words, phrases, combinations of words, or combinations of phrases.

After removing common words from the corpus, method 300 may proceed to block 340 where computing device 100 may identify a set of keywords for a particular one of the classes in the reduced corpus by identifying keywords that are common among documents in the particular class. Computing device 100 may identify keywords by first assigning a meaningfulness score to each word in the particular class for each document in the class. Computing device 100 may then add words to the set of keywords based on their respective meaningfulness scores for documents in the class. For example, if the meaningfulness scores assigned to a particular word meet certain criteria—for instance, a sufficient number of scores are zero or less—then the particular word may be added to the set of keywords

After identifying the set of keywords, method 300 may proceed to block 350 where computing device 300 may provide the set of keywords to generate a policy condition. A policy condition may be rules, procedures, or programs that control a corpus of documents and its contents. Furthermore, a policy condition may be based on keywords that distinguish types of documents and classes within the corpus. For example, a policy condition may control content-based access to documents in particular classes. Policy conditions may be based on policy keywords determined by a user after being provided the set of keywords identified in block 340. Alternatively in some implementations, computing device 100 may automatically generate a policy condition based on the set of keywords identified in block 340.

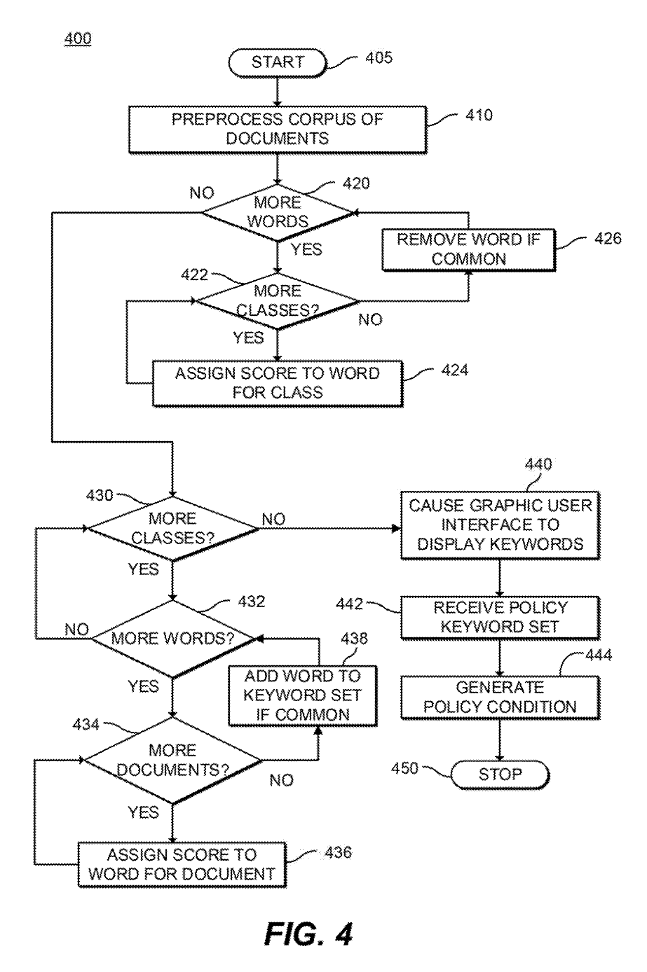

FIG. 4 depicts a flowchart of an example method 400 for providing keywords to generate policy conditions by removing, from a corpus of documents, words that are common in the corpus and adding, to a particular set of keywords, words that are common in a particular class of documents. Although execution of method 400 is described below with reference to computing device 200 of FIG. 2, other suitable components for execution of method 400 should be apparent, including computing device 100 of FIG. 1. Method 400 may be implemented in the form of executable instructions stored on a machine-readable storage medium, such as storage medium 220, and/or in the form of electronic circuitry.

Method 400 may start in block 405 and proceed to block 410, where computing device 200 may pre-process the corpus of documents. Pre-processing the corpus may edit the documents within the corpus to be better suited for the execution of the subsequent blocks of method 400. Example methods for pre-processing the corpus include removing a predefined set of character, removing words shorter than a predefined number of characters, and applying a stemming algorithm.

After pre-processing the corpus, method 400 may proceed to block 420 where computing device 200 may check whether there are any words remaining in the corpus which have not been processed by common word removing instructions 222 via execution of blocks 422, 424, and 426. If there are no more words left to be processed by common word removing instructions 222, then method 400 proceeds to block 430.

Alternatively, if there are words remaining, method 400 proceeds to block 422 where computing device 200 may check, for the particular word being processed, whether there are any remaining classes in the corpus for which a meaningfulness score is yet to be assigned. If there are remaining classes, method 400 proceeds to block 424 where a meaningfulness score is assigned to the particular word for a particular class being processed. After assigning the score to the particular word, method 400 returns to block 422. When no classes are remaining from block 422, method 400 may proceed to block 426, where computing device 200 removes the particular word being processed from the corpus if the word is common among all classes. After execution of block 426, method 400 may return to block 420.

When no words are remaining from block 420, the corpus has been condensed to a reduced corpus, and method 400 may proceed to block 430 where computing device 200 may check whether there are any classes remaining in the reduced corpus which have not been processed by keyword set identifying instructions 224 via execution of blocks 432, 434, 436, and 438. In the example shown in FIG. 4, method 400 may identify a set of keywords for every class in the reduced corpus. Alternatively, blocks 432, 434, 436, and 438 may execute once for a particular class. In method 400 shown herein, if there are no more classes left to be processed by keyword set identifying instructions 224, then method 400 proceeds to block 440.

Alternatively, if there are classes remaining, method 400 proceeds to block 432 where computing device 200 may check, for the particular class being processed, whether there are any words yet to be processed remaining in the particular class. If there are no remaining words, method 400 may return to block 430. Alternatively, if there are remaining words, method 400 proceeds to block 434 where computing device 400 may check whether there are any remaining documents in the class for which a meaningfulness score is yet to be assigned. If there are documents remaining, method 400 may proceed to block 436, where a meaningfulness score is assigned to the particular word for a given document.

After assigning the score to the particular word, method 400 returns to block 434. When no documents are remaining from block 434, method 400 may proceed to block 438, where computing device 200 adds the particular word to the set of keywords for the particular class if the word is common among documents in the particular class. After execution of block 438, method 400 may return to block 432, which may in turn direct method 400 to return to block 430.

When no classes are remaining from block 430, method 400 may proceed to block 440 where computing device 440 may cause a graphic user interface to display the sets of keywords to a user. As described above, the graphic user interface may be displayed directly by computing device 200. Alternatively, execution of block 440 may cause another device to display the keyword sets, such as via a local or cloud network. Displaying the set of keywords may allow a user to view the keywords for the class and make determinations regarding which words to use as policy keywords for setting policy conditions for the class.

After displaying the set of keywords, method 400 may proceed to block 442 where computing device 200 may interact with a user to receive a set of policy keywords from the user. The set of policy keywords may be selected by the user to guide the policy conditions. In some examples, the set of policy keywords as provided by the user may contain none, some, or all of the keywords in the sets of keywords identified by keyword set identifying instructions 224. For example, a user may want to generate policy conditions based on alternative policy keywords selected based on external knowledge. In some examples, computing device 200 may receive a set of policy keywords for some or all of the classes in the corpus.

After receiving the set of policy keywords, method 400 may proceed to block 444 where computing device 200 may generate policy conditions according to the set or sets of policy keywords. As described above, a policy condition may be rules, procedures, programs, or a combination of policies that control a corpus of documents and its contents. Furthermore, a policy condition may be based on keywords that distinguish types of documents and classes within the corpus. For example, a policy condition may control content-based access to documents in particular classes. After generating policy conditions, method 400 may proceed to block 450 where method 400 may stop.

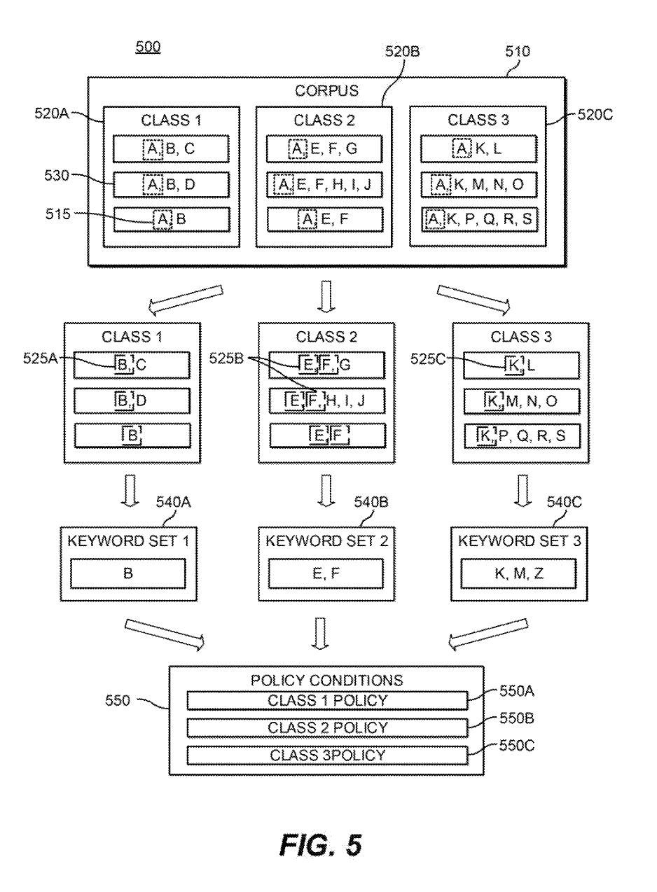

FIG. 5 is a flowchart depicting the effects, on a corpus of documents, of example method 400 depicted in FIG. 4. Although the illustration depicted in FIG. 5 is described below with reference to method 400 of FIG. 4, other suitable methods for depicting FIG. 5 should be apparent, including method 300 of FIG. 3.

In the example of FIG. 5, corpus 510 may include a plurality of classes, depicted here as class 1 (520A), class 2 (520B), and class 3 (520C). Each class includes at least one document 530. Each document 530 contains words. As depicted in the example of FIG. 5, corpus 510 contains three classes—520A, 520B, and 520C. In other examples, a corpus may include more or fewer classes. Each class contains three documents 530. Each document 530 contains at least one word labeled alphabetically as “A” to “S”, where the same alphanumeric label represents the same word. Executing common word removing instructions 222 of computing device 200 via the execution of blocks 420, 422, 424, and 426 of method 400 removes, from corpus 510, words that are common in all three classes. The common word “A” removed in this example is labeled 515 in FIG. 5.

Next, executing keyword set identifying instructions 224 via the execution of blocks 430, 432, 434, 436, and 438 first identifies words that are common among documents in each particular class. In the example of FIG. 5, “B”, which is labeled 525A, is common to class 1. “E” and “F”, which are labeled 525B, are common to class 2. “K”, which is labeled 525C, is common to class 3. These keywords may be added to the keyword set for their respective classes. Keyword set 1 (540A), keyword set 2 (540B), and keyword set 3 (540C) may then be provided to generate policy conditions 550.

As depicted in FIG. 5, keyword set 1 provides keywords for generating class 1 policy conditions 550A, keyword set 2 provides keywords for generating class 2 policy conditions 550B, and keyword set 3 provides keywords for generating class 2 policy conditions 550B. In this example, keyword set 3 contains keywords “K”, “M”, and “Z”, where “M” and “Z” are not common among documents 530 of class 3. This is to illustrate that a user may want to generate policy conditions 550 based on alternative policy keywords selected based on external knowledge.

In accordance with the foregoing, examples disclosed herein relate to a keyword providing process based on a meaningfulness score determined for each word with respect to each class within the corpus and with respect to each document within each particular class. Examples may first remove, from the corpus, words that are common among all classes. Examples may then identify as keywords words that are characteristic of a particular class. In this manner, example keyword providing procedures disclosed herein allow for accurate and efficient identification of keywords that are not only common in the class for which they are identified but are also discriminative from the other classes.

What is claimed is:

1. A non-transitory machine-readable storage medium encoded with instructions executable by a processor of a computing device, the machine-readable storage medium comprising instructions to:
remove, from a corpus of documents, words that are common among classes in the corpus to create a reduced corpus, wherein the corpus comprises documents of different classes;
identify a set of keywords for a particular one of the classes in the reduced corpus by identifying keywords that are common among documents in the particular class; and
provide the set of keywords to generate a policy condition.

2. The medium of claim 1, further comprising instructions to:
assign at least one meaningfulness score to each word in the corpus, each score associated with a given class in the corpus;
remove words from the corpus based on their respective meaningfulness scores for each class;
assign at least one meaningfulness score to each word in the particular class, each score associated with a given document in the particular class; and
add words to the set of keywords based on their respective meaningfulness scores for a sufficient number of documents.

3. The medium of claim 2, wherein the meaningfulness score is assigned to each particular word in the corpus based on the length in words of the corpus, the length in words of the given class for which the score is being assigned, the frequency of the particular word in the corpus, and the frequency of the particular word in the given class for which the score is being assigned.

4. The medium of claim 3, wherein:
the meaningfulness score is assigned to each word in the corpus according to:
$$meaningfulness score = - \frac{1}{m} log [ ( \begin{matrix}K \\ m\end{matrix} ) \frac{1}{{N}^{m - 1}} ] ,$$
where:
$$N = \frac{d}{w} ,$$
wherein d is the length in words of the corpus and w is the length in words of a specific class,
K is the frequency of the particular word in the corpus, and
m is the frequency of the particular word in the specific class; and
words with a meaningfulness score of less than or equal to a threshold score for each class are removed from the corpus.

5. The medium of claim 2, wherein:
the meaningfulness score is assigned to each particular word in the particular class based on the length in words of the particular class, the length in words of the given document for which the score is being assigned, the frequency of the particular word in the particular class, and the frequency of the particular word in the given document for which the score is being assigned; and
words with a meaningfulness score less than or equal to a threshold score for the sufficient number of documents are added to the set of keywords.

6. The memory of claim 1, wherein the instructions to provide the set of keywords to generate a policy condition comprise instructions to:
cause a graphical user interface to display the set of keywords;
interact with a user to receive a set of policy keywords; and
generate the policy condition according to the set of policy keywords.

7. The memory of claim 1, further comprising instructions to automatically generate a policy condition based on the set of keywords.

8. The medium of claim 1, wherein the policy condition is to control access to documents in the particular class based on the set of keywords.

9. The memory of claim 1, further comprising instructions to pre-process the corpus by at least one of:
removing a predefined set of characters;
removing words shorter than a predefined number of characters; and
applying a stemming algorithm.

10. A computing device, comprising a processor and a machine-readable storage medium, wherein the machine-readable storage medium comprises instructions executable by the processor to:
assign at least one meaningfulness score to each word in a corpus of documents, wherein the corpus comprises documents of different classes;
remove, from the corpus, words that are common among classes in the corpus to create a reduced corpus;
identify a set of keywords for a particular one of the classes in the reduced corpus by identifying keywords that are common among documents in the particular class;
cause a graphical user interface to display the set of keywords;
interact with a user to receive a set of policy keywords; and
generate a policy condition according to the set of policy keywords.

11. The computing device of claim 10, wherein:
at least one meaningfulness score is assigned to each particular word in the corpus, each score associated with a given class in the corpus, based on the length in words of the corpus, the length in words of the given class for which the score is being assigned, the frequency of the particular word in the corpus, and the frequency of the particular word in the given class for which the score is being assigned; and
the processor is to remove words that are common among classes in the corpus by removing, from the corpus, words with a meaningfulness score of less than or equal to a threshold score for each class.

12. The computing device of claim 10, wherein:
at least one meaningfulness score is assigned to each particular word in the particular class, each score associated with a given document in the particular class, based on the length in words of the particular class, the length in words of the given document for which the score is being assigned, the frequency of the particular word in the particular class, and the frequency of the particular word in the given document for which the score is being assigned; and
the processor is to identify the set of keywords for the particular class by adding, to the set of keywords, words with a meaningfulness score of less than or equal to a threshold score for a sufficient number of documents.

13. A method for identifying keywords, comprising:
assigning at least one meaningfulness score to each word in a corpus of documents, wherein the corpus comprises documents of different classes;
removing, from the corpus, words that are common among classes in the corpus to create a reduced corpus;
identifying a set of keywords for a particular one of the classes in the reduced corpus by identifying keywords that are common among documents in the particular class;
providing the set of keywords to generate a policy condition.

14. The method of claim 13, further comprising:
assigning at least one meaningfulness score to each word in the corpus, each score associated with a given class in the corpus;
removing words from the corpus based on their respective meaningfulness scores for each class;
assigning at least one meaningfulness score to each word in the particular class, each score associated with a given document in the particular class; and
adding words to the set of keywords based on their respective meaningfulness scores for a sufficient number of documents.

15. The method of claim 13, wherein the policy condition is to control access to documents in the particular class based on the set of keywords.
